(19) United States
(12) Patent Application Publication
(10) Pub. No.: US 2012/0258522 A1
(43) Pub. Date: Oct. 11, 2012

(54) METHOD FOR TREATING WASTE

(75) Inventor: Karlgünter Eggersmann, Marienfeld (DE)

(73) Assignee: Kompoferm GmbH, Marienfeld (DE)

(21) Appl. No.: 13/516,527

(22) PCT Filed: Nov. 9, 2010
(86) PCT No.: PCT/EP10/06811

§ 371 Date: Jun. 15, 2012

(51) Int. Cl. C12S 3/00

(52) U.S. Cl. 435/267

(57) ABSTRACT

A method of treating waste comprises first separating the waste material into at least one first fraction, preferably with waste parts above a predetermined size of waste parts, and into a second organic-rich fraction, preferably with waste parts below the specified size of waste parts. Next the second fraction is separated into at least an organic-rich fine fraction and an organic-rich coarse fraction. The organic-rich coarse fraction is dry fermentation following which the digestate is treated together with the previously separated organic-rich fine fraction to obtain deposit and/or fuel.

### TECHNICAL FIELD

The invention refers to a method for treating waste, especially domestic waste or refuse, wherein the waste is separated into a non-organic fraction and an organic fraction, wherein the organic fraction is separated by size and processed to produce a dump or fuel material is achieved.

### BACKGROUNG INFORMATION

During the aforesaid waste treatment, separation of the waste into individual fractions, for example into essentially organic material, plastic, metal and other waste products, is customarily carried out. It is the aim to make the waste dumpable or else to treat the waste for thermal utilisation. In order to maintain a dump, in particular the biological activity must be extracted from an organic proportion of the waste. This is carried out as a rule by means of an aerobic treatment or by means of a combination of aerobic and anaerobic treatment, wherein the organic-rich material is volumetrically separated.

Aerobic treatment is very costly and energy-intensive and the combined treatment which is spoken of can be technically realised only in a very limited lumpiness of the organic-rich material with particle sizes which are smaller than 60 mm.

Document DE 4 417 248 A describes a method and a device for biological decomposition of organic waste by linking a plurality of process chains with a separating device into a fine fraction and into a coarse fraction for further treatment in an aerobic rotting process.

The invention is therefore based on the object of disclosing a method for treating waste, which is optimised with regard to the aforesaid disadvantages.

### SUMMARY

According to the invention, it is intended to separate from the waste an organic-rich fraction which in a subsequent step is again divided into an organic-rich fine fraction and an organic-rich coarse fraction. The fine fraction preferably has particles with an average grain size of between 0 and 45 mm, and the coarse fraction preferably has particles with an average grain size of 10 to 120 mm. The coarse fraction is then supplied as a substrate to a dry fermentation process and in this case fermented to form a fermentation residue. The fine fraction, together with this fermentation residue, is aerobically treated and/or dried.

This procedure has the advantage that by means of the dry fermentation energy can be extracted from a part of the organic-rich fraction, producing reusable biogas, which would be lost during conventional aerobic treatment. Moreover, during the dry fermentation within the scope of the design and size of the corresponding plant, any organic-rich waste parts with almost any grain sizes can be processed.

### BRIEF DESCRIPTION OF THE DRAWINGS

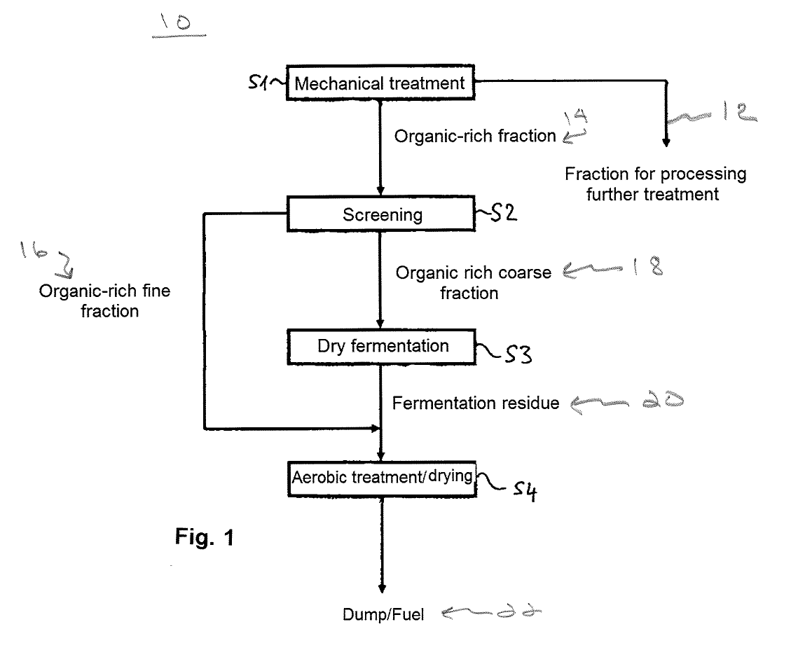

These and other features and advantages of the present invention will be better understood by reading the following detailed description, taken together with the drawing wherein:[0010] FIG. 1 is a flow diagram illustrating the steps performed in carrying out the method of the present invention.

### DETAILED DESCRIPTION OF THE PREFERRED EMBODIMENTS

The depicted flow diagram represents the process 10 according to the invention in a simplified manner. In a first step S1, mechanical processing of the waste is carried out, wherein separation of the waste into at least one first fraction 12 and into at least one organic-rich fraction 14 is carried out. Organic-rich means that this fraction in any case contains a considerable part of organic material. Step S1 can also contain a size selection according to the average waste part size or grain size, wherein the organic-rich fraction preferably contains parts with average grain sizes of 0 to 120 mm, preferably 0 to 80 mm, wherein the higher value in each case is referred to as the predetermined waste part size.

In a further step S2, a further separation, for example screening of the organic fraction, is carried out. The separation is carried out so that an organic fine fraction 16, with parts of an average grain size of 0 to 45 mm, preferably smaller than 30 mm, ideally smaller than 10 mm, is formed, and an organic coarse fraction 18, with parts of an average grain size which is equal to or above the said values in each case, is formed. In a next step S3, the resulting coarse fraction 18, as a substrate, is subjected to a dry fermentation process which as such is generally known and does not have to be explained in more detail here. By fermenting the coarse fraction in the dry fermentation step S3, a fermentation residue 20 results and at the same time biogas is produced in a controlled manner and can be extracted from the fermenter or from a percolation vessel for further use. As a result, energy is extracted from the coarse fraction and at the same time biogas is made available for further applications. The fine fraction 16, together with the fermentation residue 20, is then supplied to a further drying process and/or (aerobic) treatment so that finally a dump and/or fuel 22 can be produced in downstream treatment steps S4.

Modifications and substitutions by one of ordinary skill in the art are considered to be within the scope of the present invention, which is not to be limited except by the allowed claims and their legal equivalents.

1. A method for treating waste materials in which deposits and/or combustible material are extracted from the waste material by means of a series of treatment steps, the method comprising the following steps:
a. Separating the waste material into at least one first fraction, wherein said at least one waste fraction includes waste parts above a predetermined waste part size, and into a second organic-rich fraction, wherein said organic-rich fraction includes waste parts below the predetermined waste part size;
b. Separating the second organic-rich fraction into at least one organic-rich fine fraction and into an organic-rich coarse fraction;
c. Fermenting the organic-rich coarse fraction by means of dry fermentation process;
d. Further treating the fermented residue from the dry fermentation of the organic-rich coarse fraction together with the previously separated organic-rich fine fraction (S4).

2. The method according to claim 1, characterised in that the further treatment according to step d comprises an aerobic treatment and/or drying process.

3. The method according to claim 1 characterised in that the separation according to step b takes place by screening.

4. The method according to claim 1, characterised in that the predetermined waste part size is on average between 60 and 120 mm.

5. The method according to claim 4, characterised in that the predetermined waste part size is on average at 80 mm.

6. The method according to claim 1, characterised in that the average size of the waste parts of the organic-rich fine fraction is smaller than 10 to 45 mm.

7. The method according to claim 6, characterised in that the average size of the waste particles of the organic-rich fine-fraction is smaller than 30 mm.
